(19) United States
(12) Patent Application Publication
(10) Pub. No.: US 2004/0070162 A1
(43) Pub. Date: Apr. 15, 2004

(54) Running gear and method

(76) Inventor: Loran Nelson, Coalgate, OK (US)

Correspondence Address: Daren C. Davis, Patent Agent, William, Morgan & Amerson, P.C., 7676 Hillmont, Suite 250, Houston, TX, 77040, US

(21) Appl. No.: 10/267,803

(22) Filed: Oct. 9, 2002

(51) Int. Cl. B62D 1/00

(52) U.S. Cl. 280/149.1

(57) ABSTRACT

A running gear includes an axle assembly of a first type and an axle bracket hanger pair mounted to the first type of axle assembly and being capable of having multiple axle assembly types mounted thereto. A trailer includes an axle assembly of a first type, an axle bracket hanger pair mounted to the first type of axle assembly and being capable of having multiple axle assembly types mounted thereto, and a bed attached to the axle bracket hanger pair. A method includes providing an axle bracket hanger pair capable of having multiple axle assembly types mounted thereto, selecting an axle assembly from the multiple axle assembly types, and mounting the selected axle assembly to the axle bracket hanger pair.

### BACKGROUND OF THE INVENTION

1. Field of the Invention

This invention relates to a running gear and a method for assembling a running gear. In particular, the invention relates to a running gear for a trailer and a method for assembling a running gear.

2. Description of the Related Art

Trailers are well known in the art as containers or platforms, generally pulled by motor vehicles, for hauling various types of cargo. Such trailers are typically designed to carry no more than a specified weight of cargo. For example, a particular livestock trailer may be designed to carry no more than about 2,350 kg, while another such trailer may be designed to carry no more than about 4,600 kg. One factor determining the maximum allowable weight of the cargo that can be carried in or on the trailer is the size of the axle(s) on which the container or platform is mounted and to which the wheels and tires are attached.

It is common in the industry that a single trailer manufacturer produce several models of trailers, each having different axle sizes and, thus, different maximum allowable cargo weights. Generally, each axle has a pair of brackets attached to a corresponding pair of axle bracket hangers. The axle bracket hangers are attached to the underside of the trailer. In this way, the axles are mounted to the underside structure of the trailer.

Typically, axle brackets vary in size corresponding to the axle size. They may also have varying hole patterns for bolting or otherwise attaching the axle brackets to the axle bracket hangers. As a result, conventional axle bracket hangers have shapes and hole patterns that are specific to the axle brackets to be attached thereto. Thus, axles having different sizes, and therefore different axle bracket configurations, generally cannot be readily interchanged without modifying or replacing the axle bracket hanger. Further, trailer manufacturers generally must stock specific axle bracket hangers for each of the axle brackets to be used, thus resulting in manufacturing inefficiencies.

It is typically desirable for the bed of a trailer to be generally level when coupled with a vehicle. Accordingly, trailers are often designed so that a distance from the bed to the road surface corresponds to the hitch height of the vehicle that will be pulling the trailer. For example, a gooseneck trailer that is to be pulled by a standard pickup truck will generally have a bed-to-road height that is less than a similar trailer that is to be pulled by a truck having a modified bed, such as a “western hauler” type bed. Conventional trailers are specifically designed to be pulled by a particular type of truck. Often, if a different type of truck is desired, the trailer is replaced with one that is designed for the new type of truck.

The present invention is directed to overcoming, or at least reducing, the effects of one or more of the problems set forth above.

### SUMMARY OF THE INVENTION

In one aspect of the present invention, a running gear is provided. The running gear includes an axle assembly of a first type and an axle bracket hanger pair mounted to the first type of axle assembly and being capable of having multiple axle assembly types mounted thereto.

In another aspect of the present invention, a running gear is provided. The running gear includes axle means of a first type, means for coupling the first type of axle means to a trailer structure, and means for mounting several different axle assembly types to the means for coupling the first type of axle means to trailer structure.

In yet another aspect of the present invention, a trailer is provided. The trailer includes an axle assembly of a first type, an axle bracket hanger pair mounted to the first type of axle assembly and being capable of having multiple axle assembly types mounted thereto, and a bed attached to the axle bracket hanger pair.

In another aspect of the present invention, a trailer is provided. The trailer includes means for containing a load to be carried by the trailer, axle means of a first type, means for coupling the first type of axle means to the means for containing the load, and means for mounting several different axle assembly types to the means for coupling the first type of axle means to the means for containing the load.

In one aspect of the present invention, a method is provided. The method includes providing an axle bracket hanger pair capable of having multiple axle assembly types mounted thereto, selecting an axle assembly from the multiple axle assembly types, and mounting the selected axle assembly to the axle bracket hanger pair.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 is a perspective view of an illustrative embodiment of an unblocked trailer running gear assembly according to the present invention;

FIG. 2A is a right side view of an illustrative embodiment of an axle bracket and a portion of an axle bracket hanger according to the present invention;

FIG. 2B is a bottom view of the axle bracket and the portion of the axle bracket hanger of FIG. 2A;

FIG. 2C is a left side view of the axle bracket and the portion of the axle bracket hanger of FIG. 2A;

FIG. 2D is an end view of the axle bracket and the portion of the axle bracket hanger of FIG. 2A;

FIG. 3A is a right side view of an illustrative embodiment of an alternative axle bracket and the portion of the axle bracket hanger of FIG. 2A;

FIG. 3B is a bottom view of the alternative axle bracket and the portion of the axle bracket hanger of FIG. 3A;

FIG. 3C is a left side view of the alternative axle bracket and the portion of the axle bracket hanger of FIG. 3A;

FIG. 3D is an end view of the alternative axle bracket and the portion of the axle bracket hanger of FIG. 3A;

FIG. 4A is a stylized side view of an illustrative embodiment of a trailer according to the present invention in an unblocked configuration hitched to a truck;

FIG. 4B is a stylized side view of the unblocked trailer of FIG. 4A hitched to a larger truck;

FIG. 4C is a stylized view of the trailer of FIG. 4A in a blocked configuration hitched to the larger truck of FIG. 4B;

FIG. 5 a perspective view of an illustrative embodiment of a blocked trailer running gear assembly according to the present invention;

FIG. 6A is a right side view of the axle bracket and the portion of the axle bracket hanger of FIG. 2A spaced apart with an illustrative embodiment of a spacer block according to the present invention;

FIG. 6B is a bottom view of the axle bracket, the portion of the axle bracket hanger, and the spacer block of FIG. 6A;

FIG. 6C is a left side view of the axle bracket, the portion of the axle bracket hanger, and the spacer block of FIG. 6A;

FIG. 6D is an end view of the axle bracket, the portion of the axle bracket hanger, and the spacer block of FIG. 6A; and

FIG. 6E is a right side view of the spacer block of FIG. 6A.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

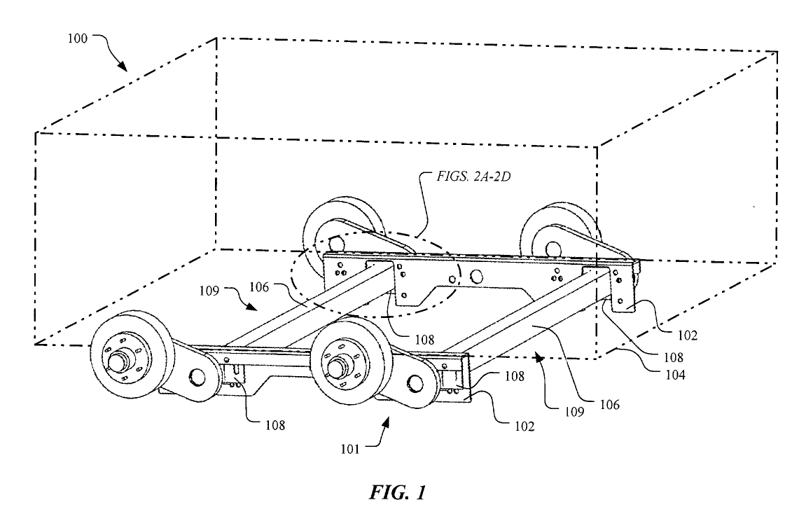

Turning now to the drawings, FIG. 1 illustrates a trailer 100 including one particular embodiment of a running gear assembly 101 constructed in accordance with the present invention. The assembly 101 includes a pair of axle bracket hangers 102 that, in use, may be attached to a trailer structure, such as a bed 104 (shown in phantom). The bed 104 may be any chosen type, e.g., a container, a flatbed, a partially enclosed container, or the like. Thus, by way of example and illustration, the bed 104 is but one means for containing a load to be carried by the trailer employed in accordance with the present invention. In the illustrated embodiment, each one of a pair of axles 106 is coupled with the axle bracket hangers 102 by a pair of axle brackets 108. One of the axles 106 and a pair of axle brackets 108 form an axle assembly 109. Thus, by way of example and illustration, the axle assembly 109 is but one axle means employed in accordance with the present invention. Further, by way of example and illustration, the axle bracket hangers 102 are but one means for coupling the axle assembly 109 to the bed 104 or trailer structure. The axle bracket hangers 102 are adapted to receive axles 106 and axle brackets 104 having varying sizes and configurations, as will be described below.

While the embodiment illustrated in FIG. 1 comprises an assembly 101 having two axles, the present invention is not so limited. Rather, a running gear assembly constructed in accordance with the present invention may have any desired number of axles 106. For example, such a running gear assembly may have one axle; thus, each of the axle bracket hangers 102 is constructed such that one axle bracket 108 may be attached thereto.

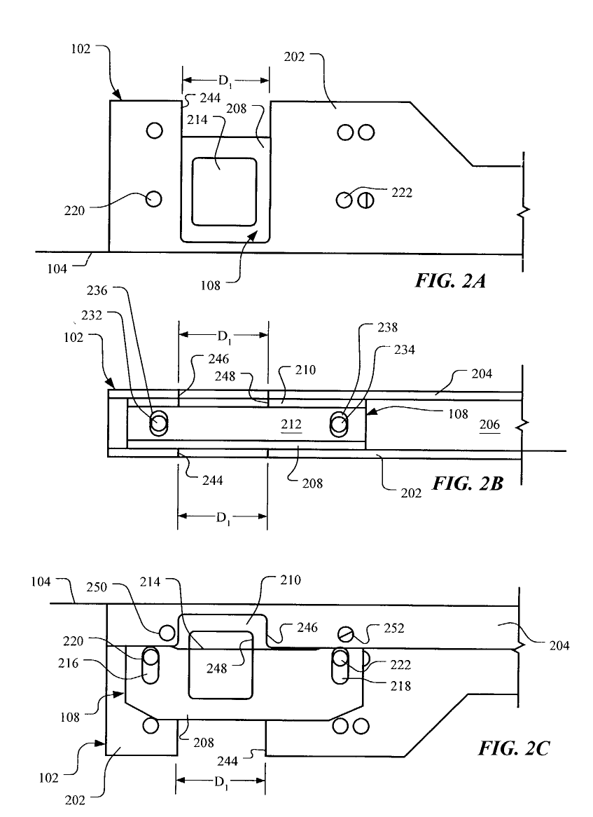

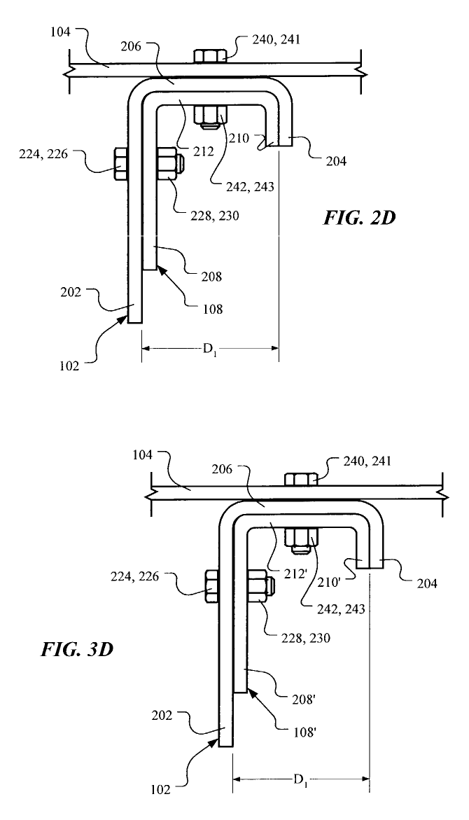

FIGS. 2A-2D illustrate a right side view, a bottom view, a left side view, and an end view, respectively of a portion of one of the axle bracket hangers 102 and one of the axle brackets 108, as indicated in FIG. 1. While the description below is provided in relation to one particular axle bracket 108 and its mating portion of the axle bracket hanger 102, the description applies equally to any of the axle brackets 108 and their corresponding mating portions of the axle bracket hangers 102. In the illustrated embodiment, the axle bracket hanger 102 is generally L-shaped in cross-section and comprises a first leg 202, a second leg 204 and a central portion 206 therebetween. The first leg 202 and the second leg 204 are sufficiently spaced apart so that the axle bracket 108 may be positioned therebetween, proximate the central portion 206.

Still referring to FIGS. 2A-2D, the axle bracket 108 in the illustrated embodiment is also generally L-shaped in cross-section. The axle bracket 108 comprises a first leg 208, a second leg 210, and a central portion 212 therebetween. The first leg 208 of the axle bracket 108 defines an axle opening 214 therethrough into which the axle 106 (shown in FIG. 1) may be mated with the axle bracket 108. The first leg 208 of the axle bracket 108 further defines a first fastener opening 216 and a second fastener opening 218 therethrough. While the fastener openings 216, 218 are illustrated as being elongated openings, the fastener openings 216, 218 may be generally round openings or openings of any other chosen shape.

In the embodiment illustrated in FIGS. 2A-2D, the first leg 202 of the axle bracket hanger 102 defines a first fastener opening 226 and a second fastener opening 228 therethrough. With the axle bracket 108 disposed between the first leg 202 and the second leg 204 of the axle bracket hanger 102, the first fastener opening 216 and the second fastener opening 218 of the axle bracket 108 may be generally aligned with the first fastener opening 220 and the second fastener opening 222, respectively, of the axle bracket hanger 102. The axle bracket 108 may be fastened to the axle bracket hanger 102 by fasteners 224, 226 disposed through the aligned openings 216, 220 and 218, 222, respectively, and engaged with nuts 228, 230, respectively. The fasteners 224, 226 and the nuts 228, 230 are shown only in FIG. 2D for clarity.

Referring particularly to FIGS. 2B and 2D, the central portion 206 of the axle hanger bracket 102 further defines a third fastener opening 232 and a fourth fastener opening 234 therethrough. The central portion 212 of the axle bracket 108 also defines a third fastener opening 236 and a fourth fastener opening 238 therethrough, corresponding to the openings 232, 234, respectively. With the axle bracket 108 disposed between the first leg 202 and the second leg 204 of the axle bracket hanger 108, the openings 232, 234 may be generally aligned with the openings 236, 238, respectively. Fasteners 240, 241 may be disposed within the openings 232, 236 and 234, 238, respectively, and engaged with nuts 242, 243, respectively, to couple the axle bracket hanger 102 and the axle bracket 108 to the bed 104. The fasteners 240, 241 and the nuts 242, 243 are shown only in FIG. 2D for clarity.

Referring again to FIGS. 2A-2D, the first leg 202 and the second leg 204 of the axle bracket hanger 102 defines slots 244, 246 therein, respectively, that allow clearance for the axle 106 (shown in FIG. 1) when mated with the opening 214. Further, the second leg 210 of the axle bracket 108 defines a slot 248 therein that also allows clearance for the axle 106 (shown in FIG. 1) when mated with the opening 214. In the illustrated embodiment, the slots 244, 246 each have a dimension D₁ that is sized so that a variety of sizes of axles 106 may be accommodated therein. The slots 244, 246 may have dimensions (e.g., the dimension D₁) that vary from each another, as long as they accommodate the various desired sizes of axles 106.

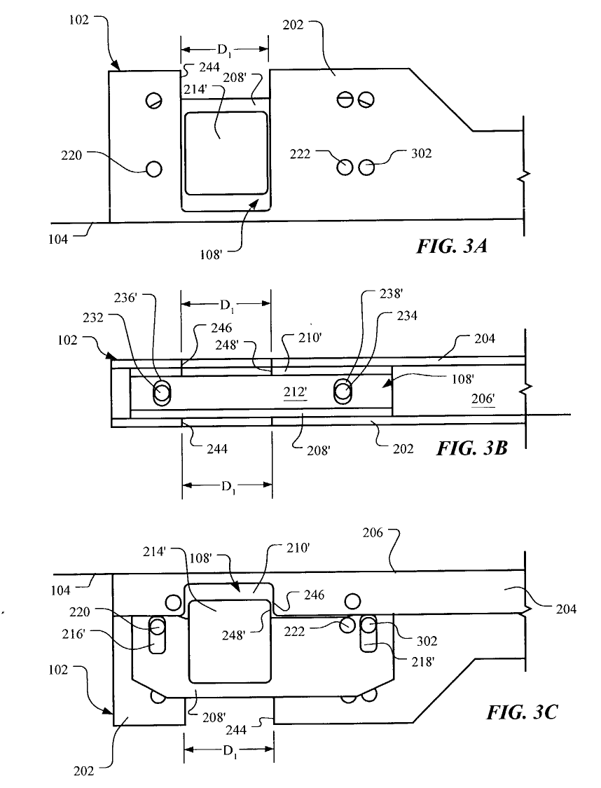

In certain situations, it may be desirable for the running gear assembly 101 to include alternate assemblies (e.g., the axle assemblies 109) having various load capacities and, thus, various corresponding cross-sectional dimensions. It may also be generally desirable, from a manufacturing efficiency standpoint, to have one or more elements of the assembly 101 that are used commonly with all axles. FIGS. 3A-3D illustrate a right side view, a bottom view, a left side view, and an end view, respectively of the portion of the axle bracket hanger 102 of FIGS. 2A-2D and an alternate axle bracket 108′. In the illustrated embodiment, the alternate axle bracket 108′ is dimensionally larger than the axle bracket 108 and has fastener openings that are spaced differently than those of the axle bracket 108.

Similar to the axle bracket 108, the axle bracket 108′ in the illustrated embodiment is generally L-shaped in cross-section. The axle bracket 108′ comprises a first leg 208′, a second leg 210′, and a central portion 212′ therebetween. The first leg 108′ of the axle bracket 108′ defines an axle opening 214′ therethrough into which a larger axle (not shown) than the axle 106 may be received. The first leg 208′ of the axle bracket 108′ further defines a first fastener opening 216′ and a second fastener opening 218′ therethrough. While the fastener openings 216′, 218′ are illustrated as being elongated openings, the fastener openings 216′, 218′ may be generally round openings or openings of any other chosen shape. Further, the second leg 210′ of the axle bracket 108′ defines a slot 248′ therein that allows clearance for the larger axle (not shown) when mated with the opening 214′.

In the embodiment illustrated in FIGS. 3A-3D, the first leg 202 of the axle bracket hanger 102 defines a fifth fastener opening 302 therethrough. With the axle bracket 108 disposed between the first leg 202 and the second leg 204 of the axle bracket hanger 202, the first fastener opening 216′ and the second fastener opening 218′ of the axle bracket 108′ may be generally aligned with the first fastener opening 220 and the fifth fastener opening 302, respectively, of the axle bracket hanger 102. The axle bracket 108′ may be fastened to the axle bracket hanger 102 by the fasteners 224, 226 disposed through the aligned openings 216′, 220 and 218′, 302, respectively, and engaged with the nuts 228, 230, respectively. The fasteners 224, 226 and the nuts 228, 230 are shown only in FIG. 3D for clarity.

Referring particularly to FIGS. 3B and 3D, the central portion 212′ of the axle bracket 108′ further defines a third fastener opening 236′ and a fourth fastener opening 238′ therethrough. As indicated previously, the central portion 212 of the axle bracket 108 also defines a third fastener opening 236 and a fourth fastener opening 238 therethrough. With the axle bracket 108 disposed between the first leg 202 and the second leg 204 of the axle bracket hanger 108, the openings 232, 234 may be generally aligned with the openings 236′, 238′, respectively. Fasteners 240, 241 may be disposed through the openings 232, 236′ and 234, 5 238′ respectively, and engaged with nuts 242, 243, respectively, to couple the axle bracket hanger 102 and the axle bracket 108 to the bed 104. The fasteners 240, 241 and the nuts 242, 243 are shown only in FIG. 3D for clarity.

Accordingly, the axle bracket hanger 102 is capable of mating with various axle brackets (e.g., the axle brackets 108, 108′) of different types and/or configurations and is, 10 thus, capable of having multiple axle assembly types mounted thereto. For example, the axle bracket hanger 102 may be coupled with axle brackets that are adapted to receive different sized axles. The axle bracket hanger 102 may also be coupled with axle brackets that are different in overall size and/or that have different fastener hole patterns. The present invention, however, is not so limited. Rather, the present invention encompasses an axle 15 bracket hanger, such as the axle bracket hanger 102, that accommodates any chosen features of axle brackets that are to be mated thereto. For example, the axle bracket hanger 102 may accommodate pins, shoulders, joggles, and the like for locating the axle brackets in a desired location on the axle bracket hangers 102.

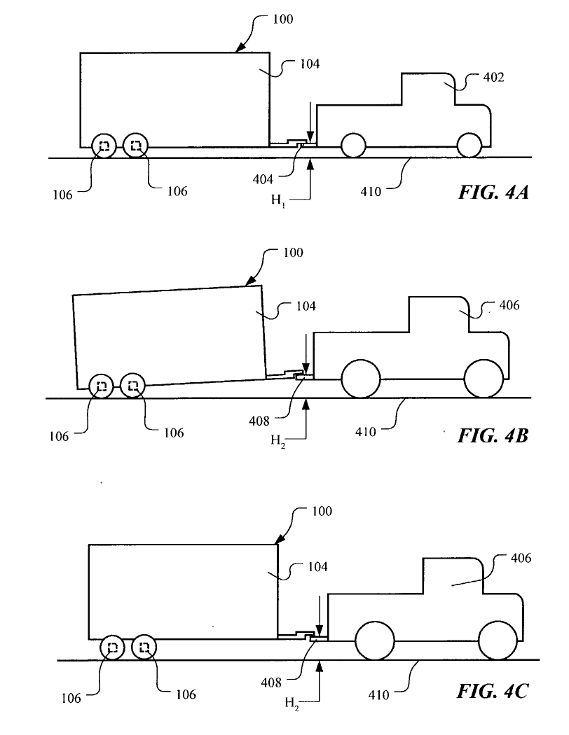

It may be desirable in certain situations to raise the axle bracket hangers 102 with 20 respect to the axle brackets 108 and the axles 106. For example, as illustrated in FIGS. 4A-4C, a smaller truck 402 having a hitch 404 may have a hitch height H₁ that is shorter than a hitch height H₂ of a larger truck 406 having a hitch 408. Generally, the hitch heights H₁, H₂ are the distances from a roadway 410 to the hitches 404, 408, respectively. Often, it is desirable for the trailer 100 to be generally level or have some other predetermined orientation with respect to the roadway 410 as it is being pulled by a vehicle (e.g., the trucks 402, 406). In the example shown in FIG. 4A, the trailer 100 is generally level with respect to the roadway 410. However, when the trailer 100 is hitched to the larger truck 406, the trailer may no longer be level with respect to the roadway 410, as illustrated in FIG. 4B, which may be undesirable. One way of overcoming this problem is to increase the distance between the axles 106 and the bed 104, as illustrated in FIG. 4C.

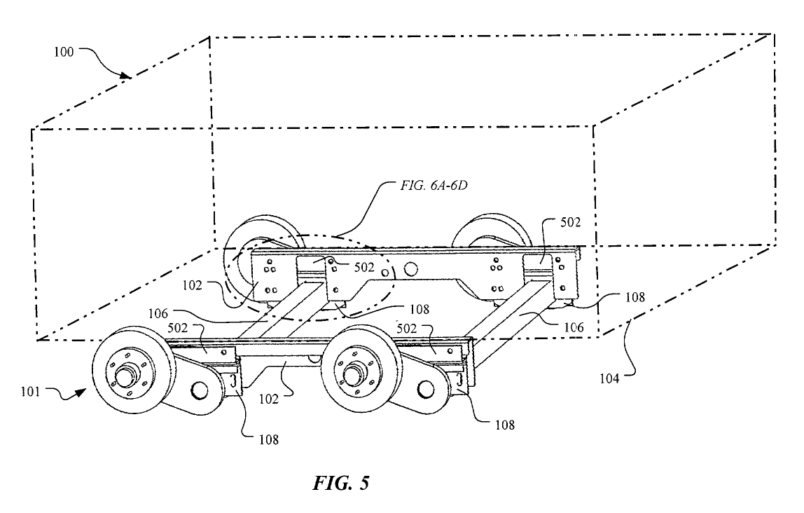

As illustrated in FIG. 5, the running gear assembly 101 further comprises, in some embodiments, a spacing block 502 disposed between each of the axle brackets 108 and the axle bracket hangers 102 to which they are attached. The spacing blocks 502 space the axle bracket 108 vertically away from the axle bracket hanger 102, such that distance between the bed 104 and the assembly 101 is increased over that shown in FIG. 1.

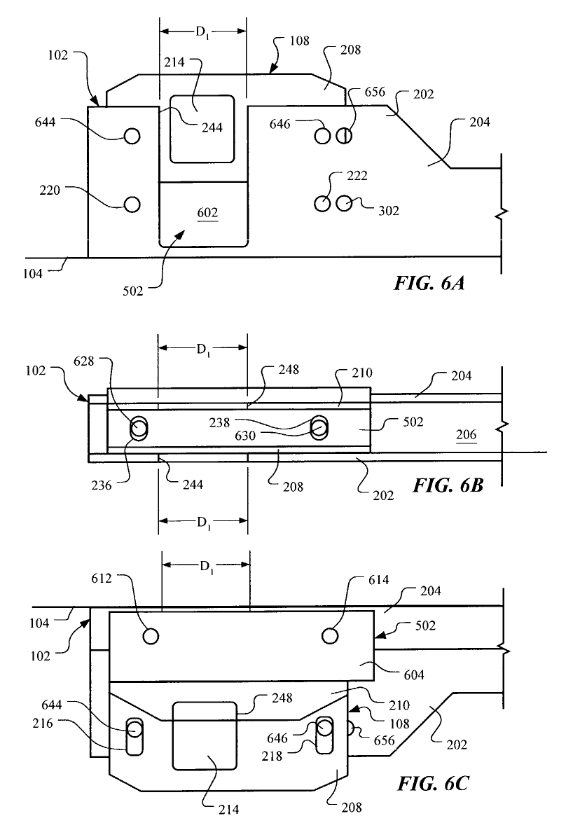

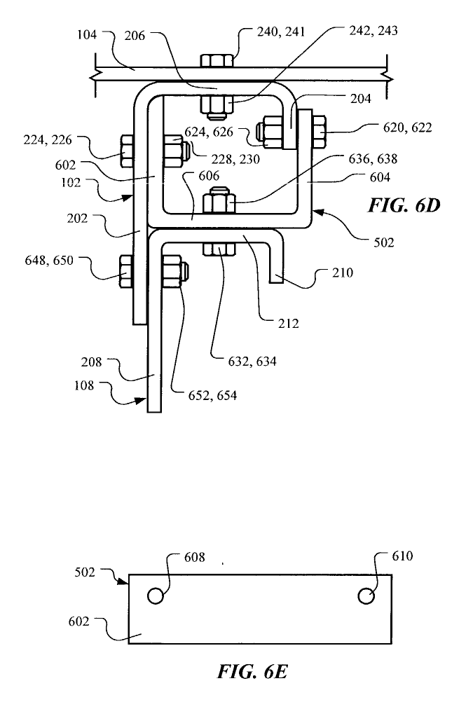

FIGS. 6A-6D illustrate a right side view, a bottom view, a left side view, and an end view, respectively of a portion of one of the axle bracket hangers 102, one of the axle brackets 108, and the spacing block 502, as indicated in FIG. 5. FIG. 6E illustrates a right side view of the spacing block 502. The spacing block 502 is disposed between the central portion 212 of the axle bracket 108 and the central portion 206 of the axle bracket hanger 102. Such an arrangement spaces the axle bracket 108 away from the central portion 206 of the axle bracket hanger 102 to increase the distance between the axle 106 (which is disposed through the opening 214 in the first leg 208 of the axle bracket 108) and the bed 104 (shown in FIG. 5). Thus, by way of example and illustration, the spacing block 502 is but one means for spacing the axle assembly 109 from the axle bracket hanger 102.

In the embodiment illustrated in FIGS. 6A-6D, the spacing block 502 is generally U-shaped in cross section and comprises a first leg 602, a second leg 604 and a central portion 606 therebetween. As shown in FIG. 6E, the first leg 602 defines a first fastener opening 608 and a second fastener opening 610 therethrough. With the spacing block 502 disposed between the axle bracket 108 and the axle bracket hanger 102, the openings 608, 610 may be generally aligned with the openings 220, 302 defined by the first leg 202 of the axle bracket hanger 102. Referring particularly to FIG. 6D, the fasteners 224, 226 may be disposed within the aligned openings 220, 608 and 302, 610, respectively, and engaged with the nuts 228, 230, respectively, to couple the axle bracket hanger 102 and the spacing block 502. The fasteners 224, 226 and the nuts 228, 230 are shown only in FIG. 6D for clarity.

Referring to FIGS. 6A-6D, the second leg 604 of the spacing block 502 defines a third fastener opening 612 and a fourth fastener opening 614 therethrough. With the spacing block 502 disposed between the axle bracket 108 and the axle bracket hanger 102, the openings 612, 614 may be generally aligned with a sixth fastener opening 250 and a seventh fastener opening 252, respectively, (shown in FIG. 2C) defined by the second leg 204 of the axle bracket hanger 102. Referring particularly to FIG. 6D, the fasteners 620, 622 may be disposed within the aligned openings 612, 250 and 614, 252, respectively, and engaged with the nuts 624, 626, respectively, to further couple the axle bracket hanger 102 and the spacing block 502. The fasteners 620, 622 and the nuts 624, 626 are shown only in FIG. 6D for clarity.

Still referring to FIGS. 6A-6D, the central portion 606 of the spacing block 502 defines a fifth fastener opening 628 and a sixth fastener opening 630 therethrough. With the spacing block 502 disposed between the axle bracket 108 and the axle bracket hanger 102, the openings 628, 630 may be generally aligned with the openings 232, 234, respectively, defined by the central portion of the axle bracket 108. Referring particularly to FIG. 6D, the fasteners 632, 634 may be disposed within the aligned openings 628, 232 and 630, 234, respectively, and engaged with the nuts 636, 638, respectively, to couple the axle bracket 108 and the spacing block 502. The fasteners 632, 634 and the nuts 636, 638 are shown only in FIG. 6D for clarity.

As shown in FIG. 6D, fasteners 240, 241 may be disposed through the openings 232, 234 (shown in FIG. 2B), respectively, and engaged with nuts 242, 243, respectively, to couple the axle bracket hanger 102 to the bed 104. The fasteners 240, 241 and the nuts 242, 243 are shown only in FIG. 6D for clarity.

As shown in FIGS. 6A-6D, the axle bracket 108 is spaced apart from the central portion 206 of the axle bracket hanger 102 in a blocked location. The first leg 202 of the axle bracket hanger 102 further defines an eighth fastener opening 644 and a ninth fastener opening 646 therethrough. The first fastener opening 216 and the second fastener opening 218 of the of the axle bracket 108 may be generally aligned with the fastener openings 644, 646, respectively, of the axle bracket hanger 102. The axle bracket may be fastened to the axle bracket hanger 102 by fasteners 648, 650 disposed through the aligned openings 216, 644 and 218, 646, respectively, and engaged with the nuts 652, 654, respectively. The fasteners 648, 650 and the nuts 652, 654 are shown only in FIG. 6D for clarity.

Still referring to FIGS. 6A-6D, the axle bracket hanger 102 further defines a tenth fastener opening 656 therethrough, so that the alternate axle bracket 108′ may be coupled with the axle bracket hanger 102 in the blocked location, i.e., with the spacer block 502 disposed between the alternate axle bracket 108′ and the axle bracket hanger. The fastener openings 216′, 218′ may be aligned with the fastener openings 644, 656, respectively, so that the alternate axle bracket 108′ may be coupled with the axle bracket hanger 102, as described relative to FIGS. 3A-3D.

Accordingly, the running gear assembly 101 can optionally include the spacing block 502 to provide additional distance between the axle 106 and the axle bracket hanger 102 and, thus, provide additional distance between the bed 104 and the roadway 410 (as shown in FIG. 4). Thus, the spacing block 502, when used in the assembly 101, provides adjustability to the assembly 101 based upon the hitch height (e.g., the hitch heights H₁ and H₂ of FIG. 4) of the towing vehicle (e.g., the trucks 402, 406).

As described above, the running gear assembly 101 includes one or more axle assemblies 109 coupled with a pair of axle bracket hangers 102. Each of the axle assemblies 109 includes an axle 106 mated with a pair of axle brackets 108, 108′. The fastener openings defined by the axle brackets 108, 108′ (i.e., the fastener openings 216, 218 of the axle bracket 108 and the fastener openings 216′, 218′ of the axle bracket 108′, respectively) that are included in the axle assembly 109 comprise a set of locating features of the axle assembly 109. The fastener openings 220, 222, 302, 644, 646, 656 of the axle bracket hanger 102 comprise a set of locating features thereof.

To locate the axle brackets 108, 108′ on the axle bracket hangers 102, certain ones of the fastener openings 220, 222, 302, 644, 646, 656 are generally aligned with the fastener openings 216, 218, 216′, 218′, depending upon which of the axle brackets 108, 108′ is to be used and depending upon where the axle brackets 108, 108′ is to be located. Thus, either of the axle brackets 108, 108′ may be located on the axle bracket hangers 102 by generally aligning the set of locating features of the axle assembly 109 (i.e., the fastener openings 216, 218, 216′, 218′) with a proper subset of the set of locating features of the axle bracket hangers 102 (e.g., the fastener openings 220, 222). A proper subset of a set is a set comprised of a sub-collection of some, but not all, of the elements of the original set.

The fastener openings 220, 222, 302, 644, 646, 656 defined by each of the axle bracket hangers 102, as illustrated in FIGS. 6A-6D, comprise a set of locating features that correspond to a set of locating features (i.e., the fastener openings 216, 218 and 216′, 218′) of each of the axle brackets 108, 108′. Thus, by way of example and illustration, the set of locating features of the axle bracket hangers is but one means for mounting several different axle assembly types to the bed 104 employed in accordance with the present invention. Either of the axle brackets 108, 108′ may be located on the axle bracket hangers 102 in a blocked location or in an unblocked location by generally aligning the locating features of the selected axle brackets 108, 108′ with the corresponding locating features of the axle bracket hanger 102. Thus, any of the axle brackets 108, 108′ may be located on the axle bracket hangers 102 by generally aligning the set of locating features of the selected axle brackets 108, 108′ with a proper subset of the set of locating features of the axle bracket hanger 102. A proper subset of a set is a set comprised of a sub-collection of some, but not all, of the elements of the original set.

For example, the axle bracket hanger 102 comprises a set of locating features including the fastener openings 220, 222 that correspond to the fastener openings 216, 218. The set of locating features of the axle bracket hanger 102 also includes other fastener openings (e.g., the fastener openings 302, 644, 646, 656) for attaching the axle bracket 108 in the blocked location, for attaching the alternate axle bracket 108′ in the unblocked location, and for attaching the alternate axle bracket 108′ in the blocked location.

As illustrated herein, the locating features of each of the axle brackets 108, 108′ (i.e., the fastener openings 216, 218 and 216′, 218′, respectively) comprise hole patterns that are unique to the particular axle bracket. The set of locating features of the axle bracket 102 includes hole patterns corresponding to each of the hole patterns of each of the axle brackets 108, 108′. For example, the fastener openings 220, 222 of the axle bracket hanger 102 comprise one hole pattern corresponding to the hole pattern that includes the fastener openings 216, 218. The fastener openings 220, 302 of the axle bracket hanger 102 comprise another hole pattern corresponding to the hole pattern that includes the fastener openings 216′, 218′.

As presented above, the axle bracket hanger 102 is capable of having multiple axle assembly types mounted thereto. An “axle assembly type”, as that phrase is used herein, is an axle assembly design distinguishable by the size, location, and/or number of locating features (e.g., the fastener openings) by which it is located on the axle bracket hangers 102, the overall size of the axle brackets 108, 108′ of which the axle assembly 109 is comprised, and/or the size and/or shape of the axle 106 of which it is comprised.

While the fasteners described and illustrated herein are of the bolt and nut type, the present invention is not so limited. Rather, any chosen types of fasteners and/or any chosen fastening means may be used to couple the various elements of the running gear assembly 101 and/or to couple the running gear assembly 101 to the trailer structure (e.g., the bed 104). For example, welds, rivets, pins, screws, and the like may be used to couple the elements of the running gear assembly 101 and/or to couple the running gear assembly 101 to the trailer structure (e.g., the bed 104).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A running gear, comprising:
an axle assembly of a first type; and
an axle bracket hanger pair mounted to the first type of axle assembly and being capable of having multiple axle assembly types mounted thereto.

2. A running gear, according to claim 1, wherein the axle bracket hanger pair is capable of having the first type of axle assembly mounted thereto in a plurality of locations.

3. A running gear, according to claim 1, wherein the axle bracket hanger pair is capable of having the multiple axle assembly types mounted thereto in a plurality of locations.

4. A running gear, according to claim 1, further comprising a spacing block pair mounted between the first type of axle assembly and the axle bracket hanger pair.

5. A running gear, according to claim 1, wherein:
the axle bracket hanger pair further comprises a first set of locating features corresponding to locating features of the multiple axle assembly types such that any of the multiple axle assembly types may be located on the axle bracket hanger pair; and
the first type of axle assembly further comprises a second set of locating features generally aligned with a proper subset of the first set of locating features.

6. A running gear, according to claim 5, wherein each of the locating features further comprises a hole pattern.

7. A running gear, according to claim 1, wherein the multiple axle assembly types may be located on the axle bracket hanger pair in a plurality of locations thereon.

8. A running gear, according to claim 1, wherein the first type of axle assembly further comprises:
an axle; and
an axle bracket pair mounted to the axle.

9. A running gear, according to claim 8, wherein:
the axle bracket hanger pair further comprises a first set of locating features corresponding to locating features of the multiple axle assembly types; and
the axle bracket pair further comprises a second set of locating features generally aligned with a proper subset of the first set of locating features.

10. A running gear, according to claim 8, wherein each of the locating features further comprises a hole pattern.

11. A running gear, comprising:
axle means of a first type;
means for coupling the first type of axle means to a trailer structure;
means for mounting several different axle assembly types to the means for coupling the first type of axle means to trailer structure.

12. A running gear, according to claim 11, wherein the axle means of the first type further comprises an axle assembly of a first type.

13. A running gear, according to claim 11, wherein the means for coupling further comprises an axle bracket hanger pair.

14. A running gear, according to claim 11, wherein the means for mounting several different axle assembly types comprises a set of locating features corresponding to locating features of the several different axle assembly types such that any of the several different assembly types may be located on the axle bracket hanger pair.

15. A running gear, according to claim 14, wherein each of the locating features further comprises a hole pattern.

16. A running gear, according to claim 11, further comprising means for spacing the axle means from the means for coupling the first type of axle means to the trailer structure.

17. A running gear, according to claim 16, wherein the means for spacing the axle means further comprises a spacing block.

18. A trailer, comprising:
an axle assembly of a first type;
an axle bracket hanger pair mounted to the first type of axle assembly and being capable of having multiple axle assembly types mounted thereto; and
a trailer structure attached to the axle bracket hanger pair.

19. A trailer, according to claim 18, wherein the axle bracket hanger pair is capable of having the first type of axle assembly mounted thereto in a plurality of locations.

20. A trailer, according to claim 18, wherein the axle bracket hanger pair is capable of having the multiple axle assembly types mounted thereto in a plurality of locations.

21. A trailer, according to claim 18, further comprising a spacing block pair mounted between the first type of axle assembly and the axle bracket hanger pair.

22. A trailer, according to claim 18, wherein:
the axle bracket hanger pair further comprises a first set of locating features corresponding to locating features of the multiple axle assembly types such that any of the multiple axle assembly types may be located on the axle bracket hanger pair; and
the first type of axle assembly further comprises a second set of locating features generally aligned with a proper subset of the first set of locating features.

23. A trailer, according to claim 22, wherein each of the locating features further comprises a hole pattern.

24. A trailer, according to claim 18, wherein the multiple axle assembly types may be located on the axle bracket hanger pair in a plurality of locations thereon.

25. A trailer, according to claim 18, wherein the first type of axle assembly further comprises:
an axle; and
an axle bracket pair mounted to the axle.

26. A trailer, according to claim 25, wherein:
the axle bracket hanger pair further comprises a first set of locating features corresponding to locating features of the multiple axle assembly types; and
the axle bracket pair further comprises a second set of locating features generally aligned with a proper subset of the first set of locating features.

27. A trailer, according to claim 25, wherein each of the locating features further comprises a hole pattern.

28. A trailer, comprising:
means for containing a load to be carried by the trailer;
axle means of a first type;
means for coupling the first type of axle means to the means for containing the load; and
means for mounting several different axle assembly types to the means for coupling the first type of axle means to the means for containing the load.

29. A trailer, according to claim 28, wherein the means for containing a load further comprises a bed.

30. A trailer, according to claim 28, wherein the axle means of the first type further comprises an axle assembly of a first type.

31. A trailer, according to claim 28, wherein the means for coupling further comprises an axle bracket hanger pair.

32. A trailer, according to claim 28, wherein the means for mounting several different axle assembly types comprises a set of locating features corresponding to locating features of the several different axle assembly types such that any of the several different assembly types may be located on the axle bracket hanger pair.

33. A trailer, according to claim 32, wherein each of the locating features further comprises a hole pattern.

34. A trailer, according to claim 28, further comprising means for spacing the axle means from the means for coupling the first type of axle means to the means for containing the load.

35. A trailer, according to claim 34, wherein the means for spacing the axle means further comprises a spacing block.

36. A method, comprising:
providing an axle bracket hanger pair capable of having multiple axle assembly types mounted thereto;
selecting an axle assembly from the multiple axle assembly types; and
mounting the selected axle assembly to the axle bracket hanger pair.

37. A method, according to claim 36, further comprising generally aligning a first set of locating features of the selected axle assembly with a proper subset of a second set of locating features of the axle bracket hanger pair.

38. A method, according to claim 37, wherein generally aligning the first set of locating features further comprises generally aligning a hole pattern of the selected axle assembly with one of a plurality of hole patterns of the axle bracket hanger pair.

39. A method, according to claim 36, further comprising mounting a spacing block between the selected axle assembly and the axle bracket hanger pair.

40. A method, according to claim 36, further comprising mounting a trailer structure to the axle bracket hanger pair.
